(19) United States
(12) Patent Application Publication
(10) Pub. No.: US 2026/0313501 A1
(43) Pub. Date: Oct. 8, 2026

(54) ASSIGNING SEAMLESS MOBILITY DOMAIN IDENTIFIERS AND SIGNALING IN REDUCED NEIGHBOR REPORTS

(71) Applicant: Cisco Technology, Inc., San Jose, CA (US)

(72) Inventors: Binita Gupta, San Diego, CA (US); Brian D. Hart, Sunnyvale, CA (US); Malcolm Muir Smith, Richardson, TX (US)

(21) Appl. No.: 19/640,998

(22) Filed: Apr. 7, 2026

Related U.S. Application Data
(60) Provisional application No. 63/787,374, filed on Apr. 11, 2025.
(60) Provisional application No. 63/784,663, filed on Apr. 7, 2025.

(51) Int. Cl. H04W 36/18; H04W 36/00

(52) U.S. Cl. CPC H04W 36/18; H04W 36/0061; H04W 36/00835

(57) ABSTRACT

Assigning Seamless Mobility Domain (SMD) identifiers (IDs) and signaling the SMD identifiers in reduced neighbor reports may be provided. Assigning SMD IDs includes assigning, by a reporting access point (AP) to a plurality of reported APs, short SMD ID values for SMDs to which the plurality of reported APs belong. The short SMD ID values are smaller in size than full SMD ID values that uniquely identify the SMDs, the short SMD ID values are assigned so the SMDs of any collocated APs of the plurality of reported APs are uniquely identified in a reduced neighbor report (RNR) element, and the short SMD ID values are assigned so the SMDs of any non-collocated APs of the plurality of reported APs are uniquely identified in the RNR element. The reporting AP transmits the RNR element comprising the short SMD ID values assigned to the plurality of reported APs.

### RELATED APPLICATION

Under provisions of 35 U.S.C. § 119(e), Applicant claims the benefit of and priority to U.S. Provisional Application No. 63/784,663, filed Apr. 7, 2025, and U.S. Provisional Application No. 63/787,374, filed Apr. 11, 2025, the disclosures of which are incorporated herein by reference in their entirety.

### TECHNICAL FIELD

The present disclosure relates generally to assigning Seamless Mobility Domain (SMD) identifiers and signaling the SMD identifiers in reduced neighbor reports.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for SMD ID assignment and signaling in accordance with aspects of the present disclosure.

FIG. 2 illustrates an example RNR element for signaling the SMD IDs of neighboring APs in accordance with aspects of the present disclosure.

FIG. 3 illustrates an example AP device comprising collocated APs in accordance with aspects of the present disclosure.

FIG. 4 is a flow diagram illustrating a method 400 of assigning short SMD IDs in accordance with aspects of the present disclosure.

FIG. 5 is a block diagram of a computing device in accordance with aspects of the present disclosure.

FIG. 6 is a block diagram of a communications device in accordance with aspects of the present disclosure.

### DETAILED DESCRIPTION

### Overview

Assigning Seamless Mobility Domain (SMD) identifiers (IDs) and signaling the SMD identifiers in reduced neighbor reports may be provided. Assigning SMD IDs includes assigning, by a reporting access point (AP) to a plurality of reported APs, short SMD ID values for SMDs to which the plurality of reported APs belong. The short SMD ID values are shorter than full SMD ID values that uniquely identify the SMDs, the short SMD ID values are assigned so the SMDs of any collocated APs of the plurality of reported APs are uniquely identified in a reduced neighbor report (RNR), and the short SMD ID values are assigned so the SMDs of any non-collocated APs of the plurality of reported APs are uniquely identified in the RNR. The reporting AP transmits the RNR comprising the short SMD ID values assigned to the plurality of reported APs.

Both the foregoing overview and the following example embodiments are examples and explanatory only and should not be considered to restrict the disclosure’s scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Roaming in Wi-Fi networks occurs when a client device (e.g., a Station (STA) or a non-Access Point Multi-Link Device (non-AP MLD)) transitions its connection from one Access Point (AP) or AP MLD to another, typically because the client device has moved outside the range of its serving AP or has identified another AP that can provide a better connection. Roaming decisions are primarily made by client devices based on Received Signal Strength Indicator (RSSI) measurements, supplemented by network recommendations from the serving AP regarding suitable neighbor APs.

Seamless roaming techniques have been developed to reduce roaming latency and improve user experience during AP transitions. Traditional non-MLD seamless roaming techniques include those described in Institute of Electrical and Electronics Engineers (IEEE) 802.11k, which reduce the time required to roam by enabling a client device to more quickly determine which AP it should roam to next, with the serving AP providing information regarding neighboring APs and their channels. Another non-MLD technique is described in IEEE 802.11r, which uses Fast Basic Service Set (BSS) Transition (FT) to allow encryption keys to be stored on all of the APs in a network, enabling a client device to avoid performing the complete authentication process to a backend server every time it roams to a new AP within the network, thus reducing authentication-related latency.

Seamless roaming as defined in the IEEE 802.11bn amendment introduces Seamless Mobility Domains (SMDs), which are logical, groupings of multiple AP MLDs that enable client devices to roam between them without disconnecting, re-authenticating, re-associating, or experiencing packet loss. SMD based seamless roaming enables a “make-before-break” approach where a device establishes a connection to a new AP MLD within the same SMD before releasing the connection with the previous AP MLD by utilizing multiple links. This allows the client device to maintain connectivity during the transition with minimum pause time, as the client device can communicate with both the serving AP MLD and the target AP MLD during roaming transition. The IEEE 802.11bn seamless roaming procedures include a roaming preparation phase during which the client device and serving AP exchange signaling to prepare one or more target APs for the upcoming roaming transition, followed by a roaming execution phase during which the actual transition to the target AP occurs. The roaming preparation phase may include negotiation of target APs, establishment of security associations with target APs, link setup, context transfer, and Quality of Service (QoS) related resource reservation on the target AP MLD, enabling the subsequent roaming execution to occur with minimal latency and data loss. Once a client device has performed roaming preparation with a target AP MLD, it then performs roaming execution to that target AP MLD to roam to that target AP. The roaming execution may involve dynamic context transfer and changing the Distribution System (DS) mapping for the client device from current AP MLD to the target AP MLD.

Within a network, each SMD can be uniquely identified using an SMD Identifier, which may be a 48-bit Media Access Control (MAC) address. In this way, SMDs can be uniquely identified independent of whether they are part of the same Extended Service Set (ESS) or different ESSs. Each Service Set Identifier (SSID) (or ESS) may host one or more SMDs, and a client device performs seamless roaming between AP MLDs that are members of the same SMD. To perform seamless roaming, a client device selects candidate neighboring APs that belong to the same SMD as its serving AP.

A Reduced Neighbor Report (RNR) is a Wi-Fi feature that allows an AP to advertise information about neighboring APs within its beacon frames and probe responses. For each reported AP, an RNR element includes a Target Beacon Transmission Time (TBTT) Information field that may carry fields such as a Neighbor AP TBTT Offset, a BSS identifier (BSSID), a Short SSID (a 4-octet hash of the full SSID, which may be up to 32 octets), BSS Parameters, a 20 MHz Power Spectral Density (PSD), and MLD Parameters. The RNR may report APs that are collocated on the same physical AP device as the reporting AP (i.e., part of the same collocated AP set), as well as non-collocated neighboring APs hosted on separate physical AP devices. Although beacon size constraints tend to limit RNR element size in beacon frames to reporting collocated APs, probe responses may include non-collocated neighboring APs as well. From the advertised neighboring AP information in the RNR element, a client device can identify candidate APs for roaming without needing to perform an exhaustive scan across all channels, saving battery life and reducing airtime congestion.

For seamless roaming (also referred to as SMD roaming or SMD BSS transition) within an SMD, the RNR must indicate, for each reported AP, which SMD that reported AP belongs to (if any). This information enables a client device to identify which reported APs belong to the same SMD as the serving AP, and thus which APs are candidates for seamless roaming. To convey SMD membership in the RNR, an SMD ID field can be carried in the TBTT Information field for each reported AP, for example, as part of Ultra High Reliability (UHR) parameters or another UHR extension added to the RNR element. The presence of such UHR parameters may additionally indicate that the reported AP is a UHR AP, and an explicit bit may alternatively be used to signal UHR AP status. If a reported AP is not part of any SMD, the SMD ID may be set to a reserved value (e.g., 255 when the SMD ID is one octet) to indicate this condition.

Because the TBTT Information field in the RNR element is repeated for every reported AP, the overhead introduced per reported AP is multiplicative. Carrying the full 48-bit SMD Identifier in the RNR for each of potentially many reported APs (e.g., 10 to 20 APs in deployments utilizing Multiple BSSID sets) would result in substantial overhead and beacon bloating. Accordingly, a short SMD ID is used in the RNR in lieu of the full SMD Identifier, with the short SMD ID being anywhere from 3 to 8 bits in length to balance overhead minimization against the need to represent a sufficient number of distinct SMDs. A 3-bit SMD ID provides only 8 possibly values and a 4-bit SMD ID provides only 16 possible values, so 3-bit or 4-bit length SMD IDs may be too restrictive outside of specific deployments. 5 or 6 bits (providing 32 or 64 values, respectively) may be preferred when overhead optimization is a priority. One octet (8 bits) provides up to 255 distinct SMD ID values, offering greater flexibility, particularly in deployments with Multiple BSSID Sets in which a single physical AP device hosts multiple SSIDs (each potentially belonging to a different SMD).

A single physical AP device may host one or more Multiple BSSID Sets. In each Multiple BSSID Set, there is one transmitted BSSID which transmits beacons on behalf of the set and one or more non-transmitted BSSIDs, and these BSSIDs operate on the same channel and share common radio resources. Each BSSID in a Multiple BSSID Set belongs to a separate SSID (e.g., a guest SSID, an employee SSID, or an IoT SSID all hosted on the same channel), and each SSID corresponds to a different SMD. Additionally, a physical AP device may host co-hosted BSSID sets (also referred to as co-hosted AP sets), in which there is a set of BSSIDs that operate on a common channel, are part of different SSIDs, and each transmit its own beacon. As a result, a single physical AP device may host a significant number of distinct SMDs across its Multiple BSSID Sets and co-hosted BSSID sets, all of which need to be identified in the RNR element.

With the limited bit width of the short SMD ID and given the potentially large number of distinct SMDs that may need to be represented across all reported APs in the RNR, it may be difficult to assign a unique short SMD ID to every distinct SMD. Furthermore, because multiple APs within the collocated AP set may each transmit beacons containing an RNR, and because non-collocated neighboring APs may also be reported in the RNR, rules must be established for how the short SMD ID is assigned, both to ensure that client devices can unambiguously identify which reported APs belong to the same SMD and to avoid conflicting or inconsistent SMD ID assignments across different reporting APs.

Described herein are mechanisms for assigning the short SMD ID for reported APs in the RNR element, including assignment rules for collocated APs within a set of collocated APs and for non-collocated neighboring APs. In some embodiments, each reporting AP independently assigns SMD ID values for collocated reported APs according to locally applied rules, requiring no coordination among AP MLDs. In other embodiments, a common management entity, on the AP device or in a controller, coordinates SMD ID assignment across APs so that every reporting AP uses consistent SMD ID values when reporting the same AP. Corresponding embodiments address SMD ID assignment for non-collocated neighboring APs, including both locally-applied and coordination-based approaches. Embodiments are described for extending coordination-based assignment uniformly across all APs within an SMD, covering both collocated and non-collocated reported APs.

In certain cases, the SMD ID value can be auto-determined from other fields already present in the RNR, for example, by leveraging the BSSID Index field from the Multiple BSSID-Index element associated with non-transmitted BSSIDs so the SMD ID need not be explicitly signaled. To support such cases, an SMD ID Present (or Valid) bit may be included to indicate whether the SMD ID field is present in the RNR for a given reported AP. In addition, a “Same SMD” bit may be used to indicate that a reported AP belongs to the same SMD as the reporting AP, in which case the SMD ID field may be reserved or omitted for that reported AP. In one approach, where the available SMD ID bit space is constrained, the SMD ID need only be unique within the scope of a given Short SSID reported in the RNR, such that the combination of <Short SSID, SMD ID> fields, rather than the SMD ID alone, serves as the unique identifier of an SMD across all reported APs in the RNR.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, as used herein, reference to reading, writing, storing, buffering, and/or transferring data can include the entirety of the data, a portion of the data, a set of the data, and/or a subset of the data.

The terms “or,” “and/or,” “at least one of,” and “one or both of” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

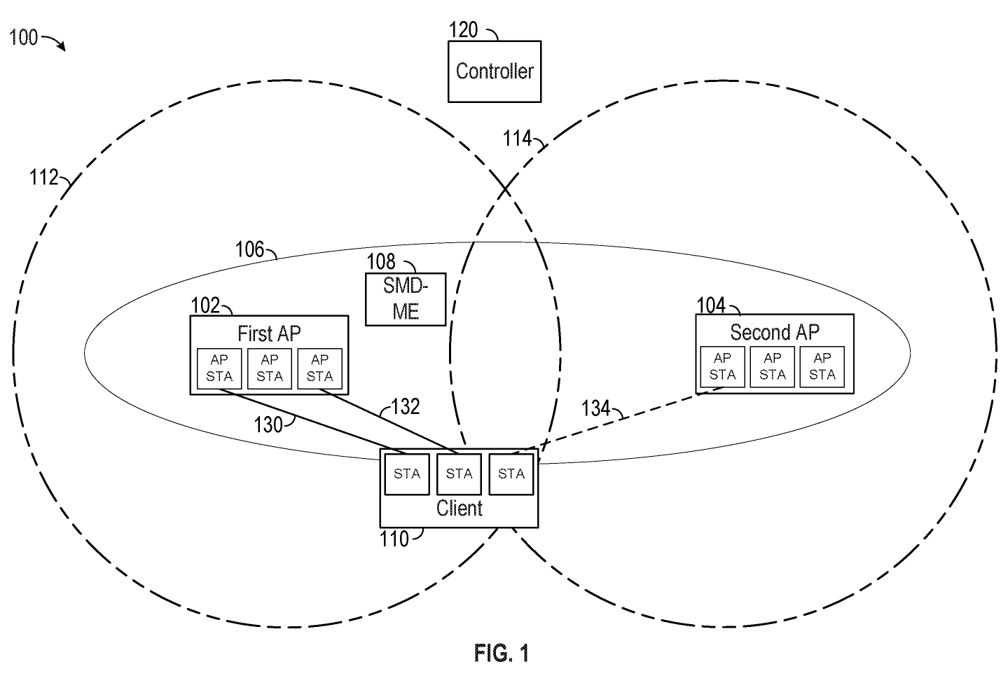

FIG. 1 is a block diagram of an operating environment 100 for SMD ID assignment and signaling can be implemented. In the illustrated embodiment, the operating environment 100 includes a first AP 102, a second AP 104, a client device 110, and a controller 120. The first AP 102 has a service area or cell indicated by the first cell 112, and the second AP 104 has a service area indicated by the second cell 114. The range of the first AP 102 and the second AP 104 may extend past the boundaries of the associated cells, resulting in overlapping coverage, but the signals grow weaker as devices move away from the respective APs. The edges of the first cell 112 and the second cell 114 as shown in the operating environment 100 are examples and may be different in other implementations (e.g., different sizes, shapes, etc.).

The APs in the operating environment 100 are grouped into one or more SMDs, such as the SMD 106 in the illustrated embodiment. The SMD 106 provides seamless roaming to clients across AP MLDs within the SMD 106. A client device 110 associates at the SMD level with an SMD-Management Entity (SMD-ME) 108 within the SMD 106 and then roams between AP MLDs within the SMD 106 without performing reauthentication or reassociation, to achieve seamless roaming. The SMD-ME 108 is a logical within the SMD 106. The first AP 102 and second AP 104 are part of the same SMD 106 in the illustrated embodiment. Each SMD may be uniquely identified within the network by an SMD Identifier, which may be a 48-bit MAC address, enabling SMDs to be uniquely distinguished independent of whether they are part of the same SSID or different SSIDs.

The client device 110 is any device that connects to the network to communicate with other devices on the network, such as a smartphone, a tablet, a personal computer, a laptop, an Internet of Things (IoT) device, and/or the like. As illustrated in FIG. 1, the client device 110 is currently associated with the SMD 106 (e.g., via the SMD-ME 108), within the first cell 112, and connected with the first AP 102. However, the client device 110 may be moving toward the boundary of the first cell 112 and into the second cell 114, indicating that the client device 110 may soon need to roam from the first AP 102 to the second AP 104 or another neighbor AP to maintain network connectivity and quality of service (QoS). To perform seamless roaming, the client device 110 selects a candidate target AP that belongs to the same SMD as its serving AP.

An AP, such as the first AP 102 and the second AP 104, is generally a fixed station that communicates with client devices and may also be referred to as a base station, wireless device, or some other terminology. The APs support seamless roaming procedures (e.g., as defined in the IEEE 802.11bn amendment), including roaming preparation and roaming execution phases, which enable the client device 110 to transition between APs (e.g., AP MLDs) within the same SMD 106 with reduced roaming latency and data loss. A single physical AP device may host multiple AP MLDs and multiple SSIDs. For example, a physical AP device may host one or more Multiple BSSID Sets. Additionally, a physical AP device may host one or more co-hosted BSSID sets, in which multiple APs operate on the same radio band and each AP transmits its own beacon. Because each SSID may be associated with a different SMD, a single physical AP device may host multiple SMDs across its Multiple BSSID Sets and co-hosted BSSID sets. The set of all APs collocated on the same physical AP device is referred to herein as the collocated AP set.

The controller 120 may be any network controller (e.g., a WLAN controller) and may manage the first AP 102, the second AP 104, the SMD 106, the SMD-ME 108, and/or other network devices (not shown) to allow wireless devices such as the client device 110 to connect to the network. In some embodiments, the operations of the controller 120 described herein may be performed by one or more of the first AP 102, the second AP 104, and/or another device, and vice versa. In some embodiments, the controller 120 is included within or integrated with an AP and coordinates the links formed by that AP. In some embodiments, the controller 120 is separate from the APs and coordinates the links of multiple APs. As described in further detail below, the controller 120 may also act as a common management entity that coordinates SMD ID assignment across APs within the collocated AP set, or more broadly across all APs within an SMD, in certain embodiments. The operating environment 100 is an example configuration and there may be a different number of clients, APs, controllers, and/or other devices in further examples.

As used herein, an AP along with the client devices associated with the AP (e.g., the client devices within the coverage area or cell of the AP) is referred to as a BSS. In the illustrated example, the first AP 102 is the serving or current AP for the client device 110 within the first cell 112. The APs may communicate with one or more client devices on the downlink (DL) and uplink (UL). The DL is the communication link from an AP to a client device 110, and the UL is the communication link from a client device 110 to an AP. In some cases, a client device 110 may also communicate peer-to-peer with another client device.

To enable a client device to identify candidate APs for seamless roaming, APs transmit RNR elements in beacon frames and probe responses. The RNR reports information about neighboring APs, including APs that are collocated on the same physical AP device as the reporting AP (i.e., within the same collocated AP set) and, in certain configurations such as probe responses, non-collocated neighboring APs hosted on separate physical AP devices. For each AP reported in the RNR, the RNR includes a TBTT Information field that may carry fields such as a Neighbor AP TBTT Offset, a BSSID, a Short SSID (a four-octet hash of the full SSID), BSS Parameters, a 20 MHz PSD, and MLD Parameters. To support seamless roaming, the RNR also carries a short SMD ID for each reported AP to indicate which SMD that reported AP belongs to. The client device 110 uses the SMD ID information in the RNR to identify which reported APs belong to the same SMD as its serving AP, and thus which APs are candidates for seamless roaming. Mechanisms for assigning the short SMD ID for reported APs in the RNR for both collocated and non-collocated reported APs are described in detail herein.

As shown in FIG. 1, the client device 110 and the APs are MLDs and each include one or more STAs. The client device 110 uses the STAs to form links with the AP STAs. For example, the client device 110 may use a first STA to form a first wireless link 130 with a corresponding STA of the first AP 102, and the client device 110 may use a second STA to form a second wireless link 132 with another STA of the first AP 102. Each STA may include Physical (PHY)-layer and lower-MAC components. The MLDs may also include an upper-MAC for coordinating the multiple STAs (or links) that are part of the MLD. The STAs can use different frequency bands for various wireless links. For example, the first wireless link 130 may be formed using a 5 GHz band and the second wireless link 132 may be formed using a 6 GHz band. These are example frequency bands and the wireless links may use any suitable frequency bands, including 2.4 GHz, 5 GHz, 6 GHz, or other bands.

In general, the AP(s) and the client device 110 may form any suitable number of links for communication using any suitable frequencies. In some instances, the client device 110 may form links with one AP (e.g., the first wireless link 130 and the second wireless link 132 with the first AP 102). In other instances, the client device 110 may form links with multiple APs (e.g., the first wireless link 130 and the second wireless link 132 with the first AP 102 and a third wireless link 134 with the second AP 104). As a result, the client device 110 may communicate with one or more APs over multiple links using different frequencies. Additionally, setup links may not always be active or otherwise useable. For example, the third wireless link 134 may be setup with the second AP 104 as part of roaming preparation, but the roaming execution may not have occurred yet. After roaming execution to the second AP 104, the third wireless link 134 becomes useable for data communication.

The controller 120 may provide coordination and control for the APs. For example, the controller 120 may handle adjustments to radio frequency power, channels, authentication, association, and security for the APs. The controller 120 may also coordinate the links formed by the client device(s) 110 with the APs. For example, the controller 120 may coordinate when the client device 110 and an AP communicate over a link using a particular frequency, the type of data communicated over a particular link, when the client device 110 and the AP form or terminate certain links, and/or when the client device 110 and AP (pre)-associate with each other to (pre)-establish certain links.

The client device 110 may be referred to as a STA MLD or non-AP MLD (e.g., a STA or client device acting as an MLD) and the first AP 102 or second AP 104 may be referred to as an AP MLD (e.g., an AP that acts as an MLD). The STA MLD and AP MLD are generally representative of any device capable of performing multi-link (ML) operations. An MLD may generally be classified based on whether it is a single radio MLD or multi-radio MLD. Single radio MLDs generally use a single radio (e.g., STA) to switch between one or more links. One category of single radio MLDs is Enhanced Multi-Link Single Radio (eMLSR). eMLSR devices generally operate one main wireless radio that can transmit and/or receive data frames on a given link, but can listen in low capability on a set of links when the device is not actively transmitting or receiving. Multi-radio MLDs may generally be classified into the following two types: (i) simultaneous transmission and reception (STR) MLD and (ii) non-STR MLD. For STR MLDs, a transmission on one link does not affect the operations of frame reception and clear channel assessment (CCA) on other links. For non-STR MLDs, the operation on one link may be restricted by the operation on another link. For example, a transmission on one link may not be allowed if it will cause reception interruption on another link.

In certain embodiments, the operating environment 100 enables the client device 110 to utilize seamless roaming techniques such as roaming without performing re-association with one or more APs, receiving neighbor reports to determine a target AP, and so on. As the client device 110 moves away from the coverage of an AP, the client device 110 may perform roaming preparation procedures to add links with a target AP MLD as it roams in the coverage of target APs within the SMD 106 to continue connectivity with the network. In certain embodiments, the beacons’ signal strength (e.g., RSSIs) from APs in the client device 110 roaming path acts as triggers for initiating roaming preparation to add links with target AP MLD(s).

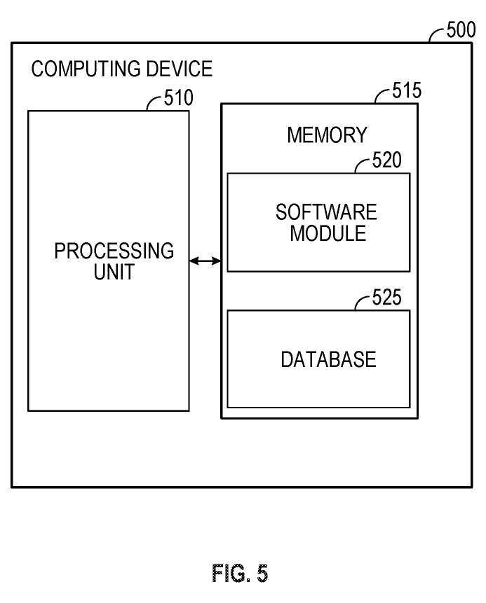

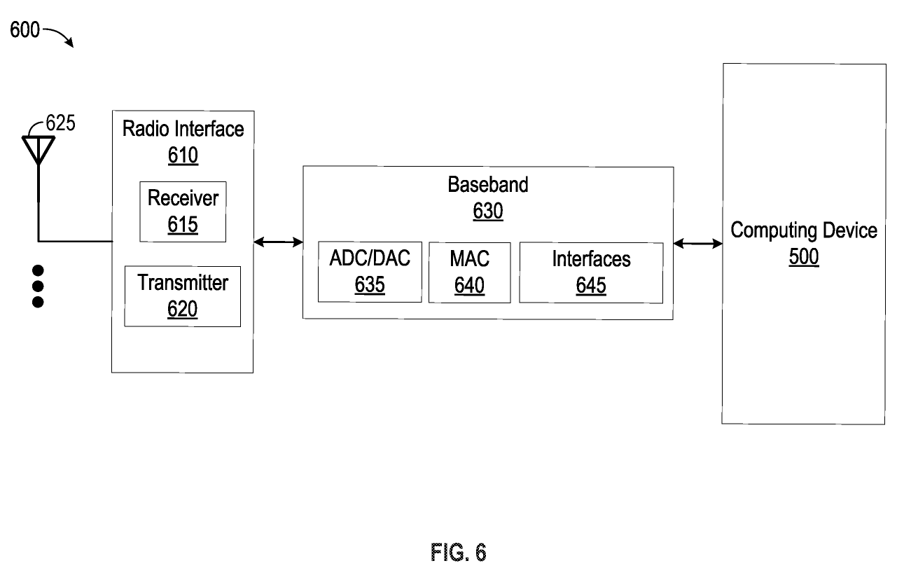

The elements described above of the operating environment 100 (e.g., the first AP 102, the second AP 104, the SMD-ME 108, the client device 110, the controller 120, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 5 and 6, the elements of the operating environment 100 may be practiced in a computing device 500 and/or communications device 600.

### SMD ID in RNR

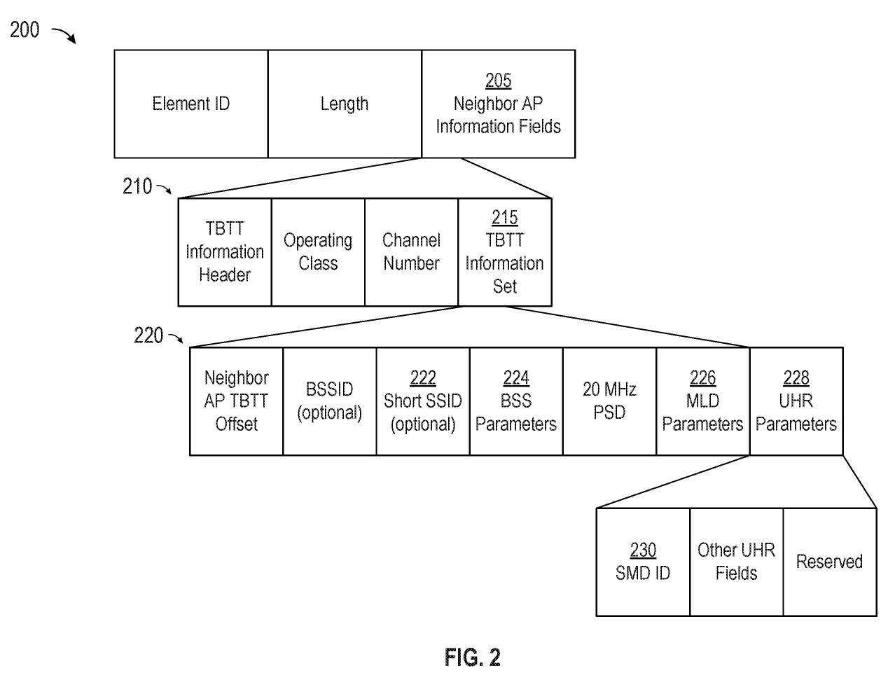

FIG. 2 illustrates an example RNR element 200 for signaling the SMD IDs of neighboring APs. The RNR element 200 includes an element ID field, a length field, and neighbor AP information fields 205 comprising one or more AP information fields 210. Each AP information field 210 includes, among other fields, a TBTT Information Set field 215 with one or more TBTT Information fields 220. In the illustrated embodiment, the TBTT Information field 220 includes, among other fields, a Short SSID field 222, a BSS Parameters field 224, an MLD Parameters field 226, and a UHR Parameters field 228. The Short SSID field 222 carries a four-octet hash of the full SSID of the reported AP. The UHR Parameters field 228 includes an SMD ID field 230 and may also include other UHR fields, such as a UHR BSS Parameter Change Count (BPCC), and reserved bits. In other embodiments, a different extension in addition to or instead of the UHR Parameters field 228 is used to carry UHR information (including the SMD ID field 230) in the RNR element 200. In some embodiments, the presence of the UHR Parameters field 228 (or other such extension) implicitly indicates that the reported AP is a UHR AP; in other embodiments, an explicit bit is used to signal UHR AP status. The UHR Parameters field 228 may be one to two octets in total length in example implementations.

As described above, the SMD ID field 230 carries a short SMD ID that identifies the SMD to which each reported AP belongs, enabling a client device to identify candidate target APs for seamless roaming. In some embodiments, the SMD ID field 230 is one octet (8 bits) in length, which provides up to 254 unique SMD IDs (e.g., with one value reserved to indicate that a reported AP is not part of any SMD and one value used to indicate that a reported AP is part of the same SMD as the reporting AP, as described below). A one-octet SMD ID field 230 is particularly useful when the reporting AP device hosts one or more Multiple BSSID Sets, since in such deployments each BSSID in a Multiple BSSID Set advertises a different SSID, and each such SSID belongs to a different SMD, resulting in a large number of distinct SMDs that must be identified in the RNR. In other embodiments, the SMD ID field 230 is 5 bits in length, providing 32 unique SMD IDs, or 6 bits in length, providing 64 unique SMD IDs. A 3-bit field providing 8 unique SMD IDs or a 4-bit SMD ID field 230 providing 16 unique SMD IDs may also be used in some implementations, but these lengths may be insufficient for many network configurations, since several Multiple BSSID Sets may be hosted on a single physical AP device and up to 16 SSIDs may be hosted on a single 6 GHz radio, leaving few remaining values after accounting for reserved values used for special cases.

To signal that a reported AP is not part of any SMD, or that the reporting AP does not have SMD information for the reported AP, the SMD ID field 230 is set to a known reserved value. For example, when the SMD ID field 230 is one octet, the reserved value may be 255 (i.e., the maximum possible value for a one-octet field), and when the SMD ID field 230 is 4 bits, the reserved value may be 15. This approach is analogous to how an AP MLD ID field in MLD Parameters uses a specific reserved value to indicate that a reported AP is not part of any AP MLD.

In some embodiments, an explicit “Part of SMD” bit is included in the RNR element 200 (e.g., in the other UHR fields of the UHR Parameters field 228) to signal whether a reported AP is part of any SMD. The “Part of SMD” bit is set to a first value (e.g., 1) to indicate that the reported AP is part of an SMD, and to a second value (e.g., 0) otherwise. In deployments where not all APs support seamless roaming, this bit provides an efficient mechanism to distinguish SMD-capable reported APs from those that are not part of any SMD.

In some embodiments, a “Same SMD” bit is included in the RNR element 200 (e.g., in the other UHR fields of the UHR Parameters field 228) to signal that a reported AP belongs to the same SMD as the reporting AP. When the Same SMD bit is set to indicate that the reported AP is in the same SMD as the reporting AP, the SMD ID field 230 may be reserved or omitted for that reported AP, since the SMD membership is already conveyed by the Same SMD bit alone. Alternatively, rather than using a dedicated Same SMD bit, the SMD ID field 230 itself may be set to a specific known value (e.g. 0) to indicate that the reported AP belongs to the same SMD as the reporting AP. In one embodiment where a specific SMD ID value (e.g., 0) is used to indicate the same SMD as reporting AP, that value is unavailable for assignment to other SMDs, and the SMD ID field 230 for reported APs that are in the same SMD as the reporting AP is set to that specific value rather than being reserved.

In some embodiments, particularly for configurations in which the SMD ID value can be automatically determined from other fields already present in the RNR or the associated frame (referred to herein as auto-determined from other fields (ADFOF)) the RNR element 200 can include an “SMD ID Present” (or “SMD ID Valid”) bit to indicate whether the SMD ID field 230 is explicitly present for a given reported AP. When the SMD ID Present bit is set to a first value (e.g., 1), the SMD ID field 230 is explicitly included for the reported AP. When set to a second value (e.g., 0), the SMD ID is not explicitly included; instead, a separate indication (e.g., the “Part of SMD” bit) signals that the reported AP is part of an SMD and that the SMD ID can be determined by applying the ADFOF rules defined for that configuration, or the SMD ID field 230 is entirely reserved or omitted. Specific cases in which the ADFOF approach applies, such as when the SMD ID can be derived from the BSSID Index field in the Multiple BSSID-Index element of a non-transmitted BSSID profile, are described in further detail below.

As noted above, the available bit width of the short SMD ID creates a challenge: a small SMD ID field 230 limits the number of unique SMD ID values available, while a reporting AP device may host many distinct SMDs across Multiple BSSID Sets and co-hosted BSSID sets. To address this challenge and enable shorter SMD IDs to be used, in some embodiments the SMD ID values are assigned such that the SMD ID need only uniquely identify an SMD within the scope of each Short SSID reported in the Short SSID field 222 of the RNR element 200. For reported APs that share the same Short SSID field 222 value, their SMD ID field 230 values are unique across all SMDs reported within that Short SSID scope. However, for reported APs with different Short SSID field 222 values, the same SMD ID field 230 value may be reused to refer to different SMDs. Under this scheme, the combination of <Short SSID, SMD ID> across all reported APs in the RNR element 200 is unique across all SMDs indicated in the RNR element 200, but the SMD ID field 230 value alone is not required to be unique across all reported APs.

Under the <Short SSID, SMD ID> scoping scheme, the following rules govern assignment of the SMD ID field 230 values. If a reported AP belongs to the same SMD as the reporting AP, the SMD ID field 230 may be set to a known value (e.g., 0), the SMD ID field 230 may be reserved, or the SMD ID field 230 may be omitted. A separate Same SMD indication bit may convey this condition. For each reported AP whose Short SSID field 222 matches that of another reported AP, the SMD ID field 230 is set to a value that is unique for the SMD corresponding to that reported AP across all SMDs reported within that same Short SSID scope. The SMD ID field 230 value may be set to any value between 0 (or greater than 0 when 0 is reserved to indicate “same SMD as reporting AP”) and the maximum possible value (or the maximum possible value minus one when the maximum is reserved to indicate a special case such as “not part of an SMD”). For two reported APs in the RNR element 200 that have different Short SSID field 222 values, the SMD ID field 230 may be set to the same value without ambiguity, since the combination <Short SSID, SMD ID> remains distinct. If a reported AP is not part of any SMD, or if the reporting AP does not have SMD information for the reported AP, the SMD ID field 230 is set to a known reserved value such as the maximum possible value for the SMD ID field 230 (e.g., 15 when the SMD ID field 230 is 4 bits, or 255 when the SMD ID field 230 is one octet).

A client device (e.g., a non-AP STA) uses the combination of <Short SSID, SMD ID> fields from the RNR element 200 to identify unique SMDs among the reported APs. If two reported APs have the same Short SSID field 222 value and the same SMD ID field 230 value, they belong to the same SMD. If two reported APs have the same Short SSID field 222 value but different SMD ID field 230 values, they belong to different SMDs. If two reported APs have different Short SSID field 222 values, regardless of whether their SMD ID field 230 values are the same or different, they belong to different SMDs, since the combination <Short SSID, SMD ID> differs. For example: (i) if Short SSID = X1 and SMD ID = N1 for two reported APs AP1 and AP2, then AP1 and AP2 belong to the same SMD; (ii) if Short SSID = X1 and SMD ID = N1 for AP1 but Short SSID = X1 and SMD ID = N2 for AP2, then AP1 and AP2 belong to different SMDs; (iii) if Short SSID = X1 and SMD ID = N1 for AP1 but Short SSID = X2 and SMD ID = N1 for AP2, then AP1 and AP2 belong to different SMDs because the Short SSID values differ; and (iv) if Short SSID = X1 and SMD ID = N1 for AP1 but Short SSID = X2 and SMD ID = N2 for AP2, then AP1 and AP2 belong to different SMDs. Thus, even though the SMD ID values (N1 in case (iii)) may be reused across different Short SSID scopes, the combination <Short SSID, SMD ID> remains unique per SMD, allowing the client device to unambiguously distinguish all SMDs represented in the RNR element 200.

In some embodiments, the UHR Parameters field 228 (e.g., including the SMD ID field 230 and any other UHR-specific fields) may not be included in the TBTT Information field 220 for reported APs affiliated with non-collocated AP MLDs, particularly when non-collocated reported APs are part of the same SMD as the reporting AP and the SMD ID field 230 is therefore unnecessary. Because the UHR Parameters field 228 may be variable in length and its presence may or may not be signaled, forward-compatible parsing mechanisms are used to indicate whether the UHR Parameters field 228 or specific fields within it, including the SMD ID field 230, are present for a given reported AP. In example implementations, one or more reserved bits from the MLD Parameters field 226 or the BSS Parameters field 224 are used to indicate the presence of the UHR Parameters field 228 or specific fields within it, enabling client devices to correctly parse the RNR element 200 and enabling forward compatibility as future generations of the standard add additional fields.

In some embodiments, when multiple BSSID sets are hosted on an AP device, the reported APs that belong to the same AP MLD may belong to different multiple BSSID sets. In this case, the SMD ID assignment for reported APs of such an AP MLD may be based on the Multiple BSSID Set to which the reporting AP belongs. In such embodiments, if a reported AP is affiliated with the same AP MLD as a non-transmitted BSSID that belongs to the same Multiple BSSID Set as the reporting AP (which corresponds to the transmitted BSSID of that Multiple BSSID Set), the SMD ID field 230 is set to the value of the BSSID Index field in the Multiple BSSID-Index element carried in the non-transmitted BSSID profile of that non-transmitted BSSID. This is an ADFOF approach where the SMD ID value is automatically determinable from the BSSID Index field already present in the Multiple BSSID-Index element, such that explicit SMD ID signaling may be unnecessary. When this Multiple BSSID Set scoping is applied, some of the reported APs belonging to different Multiple BSSID Sets that are part of different SSIDs will also have different Short SSID field 222 values, and the client device applies the same <Short SSID, SMD ID> combination logic described above to uniquely identify SMDs across different Multiple BSSID Sets.

In some embodiments, to achieve a larger effective SMD ID while limiting the number of bits added in the UHR Parameters field 228, one or more reserved bits from the MLD Parameters field 226 or the BSS Parameters field 224 are used as additional bits of the SMD ID field 230. For example, for a 5-bit SMD ID, four bits (e.g., the four least significant bits) may be carried in the SMD ID field 230 within the UHR Parameters field 228, while one additional bit (e.g., the most significant bit) is carried in the MLD Parameters field 226 or the BSS Parameters field 224. This approach enables a larger SMD ID value space with minimal additional overhead in the UHR Parameters field 228.

### SMD ID Value Assignment for Collocated APs

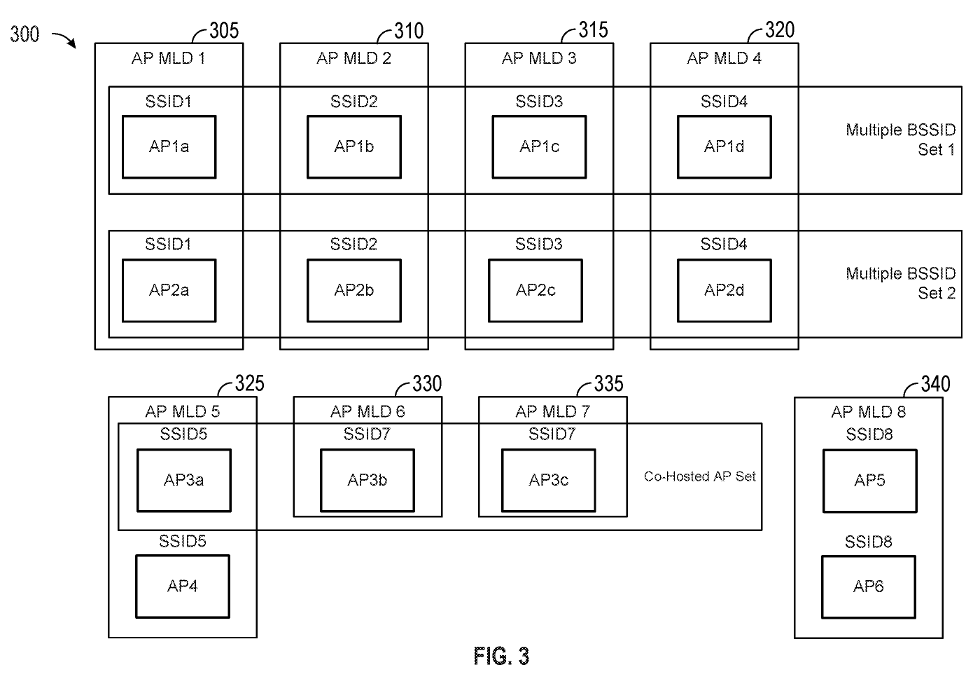

FIG. 3 illustrates an example AP device 300 comprising collocated APs. The AP device 300 includes a first AP MLD 305, a second AP MLD 310, a third AP MLD 315, a fourth AP MLD 320, a fifth AP MLD 325, a sixth AP MLD 330, a seventh AP MLD 335, and an eighth AP MLD 340.

AP1a of the first AP MLD 305, AP1b of the second AP MLD 310, AP1c of the third AP MLD 315, and AP1d of the fourth AP MLD 320 are in Multiple BSSID Set 1. AP2a of the first AP MLD 305, AP2b of the second AP MLD 310, AP2c of the third AP MLD 315, and AP2d of the fourth AP MLD 320 are in Multiple BSSID Set 2. AP3a of the fifth AP MLD 325, AP3b of the sixth AP MLD 330, and AP3c of the seventh AP MLD 335 are in a co-hosted BSSID set. The fifth AP MLD 325 further includes AP4. The eighth AP MLD 340 includes AP5 and AP6. As shown in FIG. 3, Multiple BSSID Set 1 and Multiple BSSID Set 2 each contain APs operating on the same radio band (e.g., 5 GHz), with one transmitted BSSID (e.g., AP1a and AP2a, respectively) transmitting beacons on behalf of the set and the remaining APs being non-transmitted BSSIDs. The co-hosted BSSID set APs (AP3a, AP3b, AP3c) similarly operate on the same radio band (e.g., 2.4 GHz) but each transmit their own beacon. All AP MLDs and their affiliated APs on the AP device 300 constitute the collocated AP set of the AP device 300.

When assigning SMD IDs for collocated APs in a collocated AP set on an AP device, the following embodiments are described. In a first embodiment, each reporting AP independently assigns SMD ID values for the collocated reported APs in its RNR element 200 (e.g., transmitted in a Beacon or Probe Response) with no coordination between AP MLDs in the collocated AP set. In a second embodiment, a common management entity, present on the AP device 300 or in a controller such as the controller 120, assigns a common set of SMD ID values for all SMDs hosted in the collocated AP set, and every reporting AP in the collocated AP set uses that same common set of SMD ID values when reporting the collocated APs. In either embodiment, the SMD ID values are assigned according to the rules described above with respect to FIG. 2.

When the reporting APs independently assign SMD ID values, the following SMD ID assignment rules apply for the collocated AP set. When the reporting AP (e.g., AP1a, which is the transmitted BSSID of Multiple BSSID Set 1) assigns SMD IDs for the collocated reported APs in the RNR element 200, the following three cases arise.

In the first case, if the reported AP is affiliated with the same AP MLD as the reporting AP, the SMD ID field 230 is set to a known value such as 0 to indicate that the reported AP is part of the same SMD as the reporting AP. For example, AP2a is affiliated with the same AP MLD as the reporting AP (AP1a), both belong to the first AP MLD 305, and is therefore assigned SMD ID value 0. If a separate Same SMD bit is indicated, the SMD ID field 230 may instead be reserved for that reported AP, as described above with respect to FIG. 2.

In the second case, if the reported AP is affiliated with the same AP MLD as a non-transmitted BSSID within the same Multiple BSSID Set as the reporting AP, the SMD ID field 230 is set to the BSSID Index of that non-transmitted BSSID as carried in the Multiple BSSID-Index element in the non-transmitted BSSID profile of that non-transmitted BSSID. This is an example of the ADFOF approach in which the SMD ID value is automatically determinable from an existing field. For example, AP1b and AP2b are both affiliated with the second AP MLD 310, and AP1b is a non-transmitted BSSID in Multiple BSSID Set 1 with a BSSID Index of 1; accordingly, both AP1b and AP2b are assigned SMD ID value 1. Similarly, AP1c and AP2c (third AP MLD 315) are assigned SMD ID value 2, and AP1d and AP2d (fourth AP MLD 320) are assigned SMD ID value 3, based on the BSSID Index values of AP1c and AP1d in Multiple BSSID Set 1, respectively.

An important clarification applies when an AP MLD has affiliated APs across a plurality of Multiple BSSID Sets. Because each affiliated AP of the same AP MLD must be assigned the same SMD ID value (as they belong to the same SMD) and because a given AP MLD may have APs appearing in Multiple BSSID Set 1 (e.g., AP1b) and Multiple BSSID Set 2 (e.g., AP2b), with potentially different BSSID Index values in each set, the SMD ID is assigned based on the BSSID Index of the AP in the Multiple BSSID Set of the reporting AP (e.g., Multiple BSSID Set 1 when the reporting AP is AP1a). The BSSID Index of the AP in the other Multiple BSSID Set (e.g., Multiple BSSID Set 2) is not used to reassign or override the SMD ID, ensuring that all affiliated APs of the same AP MLD consistently carry the same SMD ID value. Thus, in this case, AP2b (which is part of same AP MLD 310 as AP1b) is assigned an SMD ID value which is determined based on BSSID Index for AP1b. Same logic applies for AP2c and AP2d. Thus, the assignment of SMD ID in this case is based on the Multiple BSSID set of the reporting AP.

In the third case, if the reported AP is affiliated with an AP MLD that is neither the AP MLD of the reporting AP nor an AP MLD corresponding to a non-transmitted BSSID in the same Multiple BSSID Set as the reporting AP, such as APs in the co-hosted BSSID set (fifth AP MLD 325, sixth AP MLD 330, seventh AP MLD 335) and the eighth AP MLD 340, the SMD ID field 230 is set to a unique value assigned for the SMD corresponding to that AP MLD. These AP MLDs belong to different SSIDs than the reporting AP (and thus different SMDs), and they are not covered by the BSSID Index-based assignment rule of the second case. Accordingly, unique SMD ID values are assigned to their SMDs. When a Multiple BSSID element is present in the same frame for the Multiple BSSID set of the reporting AP, the SMD ID values assigned in this third case are greater than 2^N − 1, where N is the value carried in the Max BSSID Indicator field of the Multiple BSSID element, ensuring the third-case assignments do not conflict with the BSSID Index-based values assigned in the second case. If no Multiple BSSID element is present, the SMD ID values assigned in the third case are any values greater than 0 (when 0 is reserved to indicate “same SMD as reporting AP”) and less than the maximum reserved value (e.g., 255 for a one-octet SMD ID field 230). All affiliated APs of the same AP MLD are assigned the same SMD ID value. For example, the APs of the fifth AP MLD 325 (AP3a and AP4) are assigned SMD ID value 4, the APs of the sixth AP MLD 330 (AP3b) are assigned SMD ID value 5, the APs of the seventh AP MLD 335 (AP3c) are assigned SMD ID value 6, and the APs of the eighth AP MLD 340 (AP5 and AP6) are assigned SMD ID value 7.

When each reporting AP independently assigns SMD IDs locally, different reporting APs within the collocated AP set may assign different SMD ID values to the same reported AP. For example, AP1a may assign SMD ID value 4 to the fifth AP MLD 325, while AP3a may assign a different value to that same AP MLD.

When reporting APs coordinate SMD ID value assignment, a common set of SMD ID values is assigned for all SMDs hosted in the collocated AP set, and every reporting AP in the collocated AP set uses that same common set of values in the SMD ID field 230 when reporting the same AP in the RNR element 200. The common SMD ID values may be assigned by coordination among the AP MLDs in the collocated AP set, or by a common management entity present on the AP device 300 or in the controller 120. SMD ID value 0 is not assigned to any SMD in the common set, since value 0 is reserved to indicate that the reported AP belongs to the same SMD as the reporting AP.

The coordinated SMD ID values are assigned according to the following rules. Each SSID hosted by the collocated AP set corresponds to a different SMD, and therefore a different SMD ID is assigned to APs that belong to different SSIDs. All affiliated APs of the same AP MLD are assigned the same SMD ID value. As a result, all APs corresponding to the same SSID across the collocated AP set are assigned the same SMD ID. With eight SSIDs hosted on the AP device 300, SMD IDs 1 through 8 are assigned as follows: the APs of the first AP MLD 305 are assigned SMD ID 1, the APs of the second AP MLD 310 are assigned SMD ID 2, the APs of the third AP MLD 315 are assigned SMD ID 3, the APs of the fourth AP MLD 320 are assigned SMD ID 4, the APs of the fifth AP MLD 325 are assigned SMD ID 5, the APs of the sixth AP MLD 330 are assigned SMD ID 6, the APs of the seventh AP MLD 335 are assigned SMD ID 7, and the APs of the eighth AP MLD 340 are assigned SMD ID 8. When a reporting AP (e.g., AP1a) reports another AP that is part of the same SMD (e.g., AP2a of the first AP MLD 305, which shares SSID 1 with AP1a), it sets the SMD ID field 230 to 0, rather than to the common assigned value of 1, to indicate that the reported AP belongs to the same SMD as the reporting AP.

In embodiments where a separate Same SMD bit is used to signal that a reported AP belongs to the same SMD as the reporting AP, the SMD ID field 230 for that reported AP does not need to be set to 0. The SMD field 230 may instead be set to the common SMD ID value assigned to that SMD (e.g., 1 for the first AP MLD 305), since the Same SMD condition is already conveyed by the Same SMD bit. This same interaction between the Same SMD bit and the SMD ID field 230 applies in the non-collocated embodiments described below.

### SMD ID Value Assignment for Non-Collocated APs

For non-collocated neighboring APs reported in the RNR frame 200, the following embodiments describe SMD ID assignment rules. The RNR frame 200 in a beacon typically reports only collocated APs due to beacon size constraints or beacon bloating concerns, but the RNR frame 200 carried in a probe response may also include non-collocated neighboring APs. In some embodiments, beacon frames may also report non-collocated neighboring APs in the RNR element e.g. when RNR size is not a concern for beacon bloating because only a limited number of non-collocated neighboring APs are reported in the RNR. Accordingly, the non-collocated embodiments described below apply primarily in the context of probe responses, though they may apply to beacon-carried RNR frames as well.

In one embodiment, each AP MLD independently assigns SMD ID values for the non-collocated neighboring APs it reports in its RNR element 200, with no coordination among AP MLDs in the collocated AP set. The following rules govern the assignment.

Every affiliated AP of an AP MLD uses the same SMD ID value in the SMD ID field 230 when reporting the affiliated APs of the same non-collocated AP MLD in the RNR element 200. The same SMD ID is assigned to all non-collocated APs affiliated with the same non-collocated AP MLD, since all affiliated APs of an AP MLD belong to the same SMD. If a non-collocated reported AP belongs to the same SMD as one of the collocated AP MLDs, the same SMD ID value used for the collocated AP MLD is also used for the non-collocated AP MLD.

The SMD ID field 230 value for non-collocated reported APs is assigned according to the following rules. First, if the non-collocated reported AP is affiliated with an AP MLD that is part of the same SMD as the reporting AP’s AP MLD, the SMD ID field 230 is set to 0 or another known value, or, if a Same SMD bit is indicated, the SMD ID field 230 may be reserved (e.g., this can be a case for ADFOF). Second, if the non-collocated reported AP is affiliated with an AP MLD that is part of the same SMD as the AP MLD corresponding to a non-transmitted BSSID that belongs to the same Multiple BSSID Set as the reporting AP (which corresponds to the transmitted BSSID of that Multiple BSSID Set), the SMD ID field 230 is set to the BSSID Index of that non-transmitted BSSID as carried in the Multiple BSSID-Index element in the non-transmitted BSSID profile (e.g., this can be a case for ADFOF). Third, if the non-collocated reported AP is affiliated with an AP MLD that is neither part of the same SMD as the reporting AP’s AP MLD nor part of the same SMD as an AP MLD corresponding to a non-transmitted BSSID in the same Multiple BSSID Set as the reporting AP, the SMD ID field 230 is set to a value that is unique for the SMD corresponding to that non-collocated AP MLD in the RNR element 200 sent by the reporting AP. If a non-collocated reported AP belongs to the same SMD as one of the collocated AP MLDs, the same SMD ID value is used for both the collocated and non-collocated AP MLDs. If the non-collocated reported AP is not part of any SMD, or if the reporting AP does not have SMD information for the non-collocated reported AP, the SMD ID field 230 is set to a known reserved value (e.g., 255 when the SMD ID field 230 is one octet in length).

This scheme does not require coordination among AP MLDs to assign SMD IDs for non-collocated AP MLDs. Each AP MLD in the collocated AP set independently assigns SMD ID values for the non-collocated reported APs by following the above rules without coordination, and as long as the rules are applied consistently, there is no conflict in terms of SMD ID assignment by a given AP MLD. However, because each AP MLD performs this assignment locally, different AP MLDs in the collocated AP set may assign different SMD ID values to the same non-collocated reported AP.

In another embodiment, AP MLDs within the collocated AP set coordinate when assigning SMD IDs for non-collocated reported APs. In this embodiment, every reporting AP in the collocated AP set uses the same SMD ID value in the SMD ID field 230 when reporting the same non-collocated AP in the RNR element 200 (except that if the reported AP is part of the same SMD as the reporting AP, the SMD ID field 230 is set to 0 or another known value, unless a separate Same SMD bit is used, in which case the SMD ID may be set to the assigned SMD ID for that SMD). A common management entity, such as the controller 120 or a managing entity on the AP device 300, assigns unique SMD ID values for the non-collocated reported AP MLDs. The rules applied are: a unique SMD ID is assigned for each SMD corresponding to the non-collocated reported APs; the same SMD ID is assigned to all non-collocated APs affiliated with the same non-collocated AP MLD; and, if a non-collocated AP belongs to the same SMD as one of the collocated AP MLDs, the same SMD ID value used for the collocated AP MLD is also used for the non-collocated AP MLD. If the non-collocated reported AP is not part of any SMD, or if the reporting AP does not have SMD information for the non-collocated reported AP, the SMD ID field 230 is set to a known reserved value (e.g., 255 when the SMD ID field 230 is one octet). As a result, every AP in the collocated AP set uses the same numeric value in the SMD ID field 230 when reporting the same non-collocated AP in the RNR element 200. For example, every AP on the AP device 300 would use the same SMD ID value when reporting the affiliated APs of a neighboring AP MLD hosted on a separate AP device.

### Generalized SMD ID Value Assignment

In some embodiments, given the close collaboration of AP MLDs within an SMD, the coordinated assignment rules described above can be generalized across both collocated and non-collocated reported APs. In this generalized embodiment, every AP in an SMD uses the same value in the SMD ID field 230 when reporting the same collocated or non-collocated AP in the RNR element 200, and sets the SMD ID field 230 values either using the rules defined above (including the BSSID Index-based rule for SMD ID assignment for Multiple BSSID Set members) or by having a management entity assign unique SMD ID values for the SMDs of all reported APs across the collocated and non-collocated AP sets. The SMD ID field 230 for a reported AP that is part of the same SMD as the reporting AP may be set to 0 or another known value, or may reflect the assigned SMD ID for that SMD if a Same SMD bit is used to separately signal the same-SMD condition.

In these embodiments, there can be up to 254 unique SMD IDs supported (when the SMD ID field 230 is one octet in length and two values are reserved, such as 0 to indicate “same SMD as reporting AP” and 255 to indicate “not part of an SMD or SMD information unknown”). When this condition cannot be met (e.g., when the number of distinct SMDs that must be identified in the RNR exceeds the available unique SMD ID values) the individual rules for the collocated AP SMD ID value assignment or the non-collocated AP SMD ID value assignment rules described above must be used in the deployment, as those embodiments allow SMD ID values to be reused across different Short SSID scopes or independently assigned by individual reporting APs.

### Methods

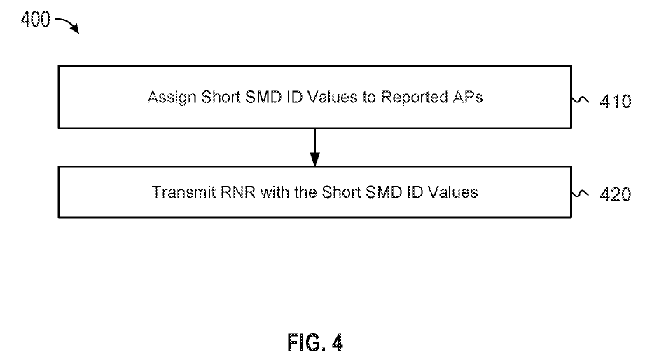

FIG. 4 is a flow diagram illustrating a method 400 of assigning short SMD IDs for reported APs in an RNR. The method 400 may be performed by a reporting AP, such as the first AP 102 or second AP 104, optionally in conjunction with a management entity such as the controller 120.

At block 410, the reporting AP assigns short SMD ID values for SMDs to which a plurality of reported APs belong. The short SMD ID values are smaller in size than full SMD ID values that uniquely identify the SMDs in the network. The short SMD ID values are assigned so that the SMDs of any collocated APs among the plurality of reported APs are uniquely identified in the RNR, and so that the SMDs of any non-collocated APs among the plurality of reported APs are uniquely identified in the RNR.

In a first embodiment, the short SMD ID values for the collocated APs are assigned locally and independently by the reporting AP without coordination with other APs in the collocated AP set. In this embodiment, assigning the short SMD ID values for the collocated APs comprises setting the short SMD ID value for a first reported collocated AP to a first designated value when the first reported collocated AP is affiliated with the same AP MLD as the reporting AP; setting the short SMD ID value for a second reported collocated AP to a BSSID Index of a non-transmitted BSSID, as carried in a Multiple BSSID-Index element in the non-transmitted BSSID profile of that non-transmitted BSSID, when the second reported collocated AP is affiliated with the same AP MLD as a non-transmitted BSSID in the same Multiple BSSID Set as the reporting AP; and setting the short SMD ID value for a third reported collocated AP to a value that is unique for the SMD of that reported AP in the RNR, when the third reported collocated AP is affiliated with an AP MLD that is neither the AP MLD of the reporting AP nor an AP MLD corresponding to a non-transmitted BSSID in the same Multiple BSSID Set as the reporting AP.

In a second embodiment, the reporting AP uses a common management entity, such as the controller 120 or a managing entity on the AP device 300, to assign the short SMD ID values for the collocated APs such that every reporting AP in the collocated AP set uses coordinated SMD ID values.

In a third embodiment, the short SMD ID values for the non-collocated APs are assigned locally and independently by the reporting AP without coordination with other APs in the collocated AP set. In a fourth embodiment, the reporting AP uses a common management entity to assign the short SMD ID values for the non-collocated APs such that every reporting AP in the collocated AP set uses coordinated SMD ID values. In a fifth embodiment, every AP in the SMD of the reporting AP uses the same short SMD ID value when reporting the same reported AP, whether the reported AP is collocated or non-collocated with the reporting AP. In a sixth embodiment, the short SMD ID values are assigned such that the short SMD ID value uniquely identifies an SMD within the scope of each Short SSID value reported in the RNR. Additional details regarding these embodiments are described above with respect to FIGS. 2 and 3.

At block 420, the reporting AP transmits the RNR comprising the short SMD ID values assigned to the plurality of reported APs at block 410.

### Systems

FIG. 5 is a block diagram of a computing device 500. As shown in FIG. 5, computing device 500 may include a processing unit 510 and a memory unit 515. Memory unit 515 may include a software module 520 and a database 525. While executing on processing unit 510, software module 520 may perform, for example, processes for assigning SMD IDs and signaling the SMD IDs. Computing device 500, for example, may provide an operating environment for the first AP 102, the second AP 104, the SMD-ME 108, the client device 110, the controller 120, and the like. The first AP 102, the second AP 104, the SMD-ME 108, the client device 110, the controller 120, and the like may operate in other environments and are not limited to computing device 500.

Computing device 500 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 500 may comprise any computer operating environment, such as hand-held devices, multiprocessor systems, microprocessor-based or programmable sender electronic devices, minicomputers, mainframe computers, and the like. Computing device 500 may also be practiced in distributed computing environments where tasks are performed by remote processing devices. The aforementioned systems and devices are examples, and computing device 500 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from, other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a SOC where each or many of the elements illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 500 on the single integrated circuit (chip).

FIG. 6 illustrates an implementation of a communications device 600 that may implement one or more of the first AP 102, the second AP 104, the SMD-ME 108, the client device 110, the controller 120, etc. In various implementations, the communications device 600 may comprise a logic circuit. The logic circuit may include physical circuits to perform operations described for one or more of the first AP 102, the second AP 104, the SMD-ME 108, the client device 110, the controller 120, etc., for example. As shown in FIG. 6, the communications device 600 may include one or more of, but is not limited to, a radio interface 610, baseband circuitry 630, and/or the computing device 500.

The communications device 600 may implement some or all of the structures and/or operations for the first AP 102, the second AP 104, the SMD-ME 108, the client device 110, the controller 120, etc., storage medium, and logic circuit in a single computing entity, such as entirely within a single device. Alternatively, the communications device 600 may distribute portions of the structure and/or operations using a distributed system architecture, such as a client station server architecture, a peer-to-peer architecture, a master-slave architecture, etc.

A radio interface 610, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 610 may include, for example, a receiver 615 and/or a transmitter 620. The radio interface 610 may include bias controls, a crystal oscillator, and/or one or more antennas 625. In additional or alternative configurations, the radio interface 610 may use oscillators and/or one or more filters, as desired.

The baseband circuitry 630 may communicate with the radio interface 610 to process, receive, and/or transmit signals and may include, for example, an Analog-To-Digital Converter (ADC) for down converting received signals with a Digital-To-Analog Converter (DAC) 635 for up converting signals for transmission. Further, the baseband circuitry 630 may include a baseband or PHY layer processing circuit for the PHY link layer processing of respective receive/transmit signals. Baseband circuitry 630 may include, for example, a MAC processing circuit 640 for MAC/data link layer processing. Baseband circuitry 630 may include a memory controller for communicating with MAC processing circuit 640 and/or a computing device 500, for example, via one or more interfaces 645.

In some configurations, PHY processing circuit may include a frame construction and/or detection module, in combination with additional circuitry such as a buffer memory, to construct and/or deconstruct communication frames. Alternatively or in addition, MAC processing circuit 640 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

1. A method comprising:
assigning, by a reporting access point (AP) to a plurality of reported APs, short seamless mobility domain (SMD) identifier (ID) values for SMDs to which the plurality of reported APs belong, wherein:
the short SMD ID values are smaller in size than full SMD ID values that uniquely identify the SMDs,
the short SMD ID values are assigned so the SMDs of any collocated APs of the plurality of reported APs are uniquely identified in a reduced neighbor report (RNR) element, and
the short SMD ID values are assigned so the SMDs of any non-collocated APs of the plurality of reported APs are uniquely identified in the RNR element; and
transmitting, by the reporting AP, the RNR element comprising the short SMD ID values assigned to the plurality of reported APs.

2. The method of claim 1, wherein the short SMD ID values for the collocated APs are assigned locally and independently by the reporting AP without coordination with other APs in a collocated AP set.

3. The method of claim 2, wherein assigning the short SMD ID values for the collocated APs comprises:
setting the short SMD ID value for a first reported collocated AP to a first designated value when the first reported collocated AP is affiliated with a same AP Multi-Link Device (MLD) as the reporting AP;
setting the short SMD ID value for a second reported collocated AP to a basic service set ID (BSSID) Index of a non-transmitted BSSID, as carried in a Multiple BSSID-Index element in a non-transmitted BSSID profile of that non-transmitted BSSID, when the second reported collocated AP is affiliated with the same AP MLD as a non-transmitted BSSID in a same Multiple BSSID Set as the reporting AP; and
setting the short SMD ID value for a third reported collocated AP to a value that is unique for the SMD of that reported AP in the RNR element, when the third reported collocated AP is affiliated with an AP MLD that is neither the AP MLD of the reporting AP nor an AP MLD corresponding to a non-transmitted BSSID in the same Multiple BSSID Set as the reporting AP.

4. The method of claim 1, wherein the reporting AP uses a common management entity to assign the short SMD ID values for the collocated APs such that every reporting AP in a collocated AP set uses coordinated SMD ID values.

5. The method of claim 1, wherein the short SMD ID values for the non-collocated APs are assigned locally and independently by the reporting AP without coordination with other APs in a collocated AP set.

6. The method of claim 1, wherein the reporting AP uses a common management entity to assign the short SMD ID values for the non-collocated APs such that every reporting AP in a collocated AP set uses coordinated SMD ID values.

7. The method of claim 1, wherein every AP in a SMD of the reporting AP uses a same short SMD ID value when reporting the same reported AP, whether the reported AP is collocated or non-collocated with the reporting AP.

8. The method of claim 1, wherein the short SMD ID values are assigned such that the short SMD ID value uniquely identifies an SMD within a scope of each short service set identifier (short SSID) value reported in the RNR element.

9. A system comprising:
a memory storage; and
a processing unit coupled to the memory storage, wherein the processing unit is operative to:
assign, to a plurality of reported access points (APs), short seamless mobility domain (SMD) identifier (ID) values for SMDs to which the plurality of reported APs belong, wherein:
the short SMD ID values are smaller in size than full SMD ID values that uniquely identify the SMDs,
the short SMD ID values are assigned so the SMDs of any collocated APs of the plurality of reported APs are uniquely identified in a reduced neighbor report (RNR) element, and
the short SMD ID values are assigned so the SMDs of any non-collocated APs of the plurality of reported APs are uniquely identified in the RNR element; and
transmit the RNR element comprising the short SMD ID values assigned to the plurality of reported APs.

10. The system of claim 9, wherein the short SMD ID values for the collocated APs are assigned locally and independently coordination with other APs in a collocated AP set.

11. The system of claim 10, wherein to assign the short SMD ID values for the collocated APs comprises to:
set the short SMD ID value for a first reported collocated AP to a first designated value when the first reported collocated AP is affiliated with a same AP Multi-Link Device (MLD) as a reporting AP;
set the short SMD ID value for a second reported collocated AP to a basic service set ID (BSSID) Index of a non-transmitted BSSID, as carried in a Multiple BSSID-Index element in a non-transmitted BSSID profile of that non-transmitted BSSID, when the second reported collocated AP is affiliated with the same AP MLD as a non-transmitted BSSID in a same Multiple BSSID Set as the reporting AP; and
set the short SMD ID value for a third reported collocated AP to a value that is unique for the SMD of that reported AP in the RNR element, when the third reported collocated AP is affiliated with an AP MLD that is neither the AP MLD of the reporting AP nor an AP MLD corresponding to a non-transmitted BSSID in the same Multiple BSSID Set as the reporting AP.

12. The system of claim 9, wherein to assign the short SMD ID values for the collocated APs comprises to use a common management entity such that every reporting AP in a collocated AP set uses coordinated SMD ID values.

13. The system of claim 9, wherein the short SMD ID values for the non-collocated APs are assigned locally and independently without coordination with other APs in a collocated AP set.

14. The system of claim 9, wherein to assign the short SMD ID values for the non-collocated APs comprises to use a common management entity such that every reporting AP in a collocated AP set uses coordinated SMD ID values.

15. A non-transitory computer-readable medium that stores a set of instructions which when executed by a processing unit, cause the processing unit to perform a method comprising:
assigning, to a plurality of reported access points (APs), short seamless mobility domain (SMD) identifier (ID) values for SMDs to which the plurality of reported APs belong, wherein:
the short SMD ID values are smaller in size than full SMD ID values that uniquely identify the SMDs,
the short SMD ID values are assigned so the SMDs of any collocated APs of the plurality of reported APs are uniquely identified in a reduced neighbor report (RNR) element, and
the short SMD ID values are assigned so the SMDs of any non-collocated APs of the plurality of reported APs are uniquely identified in the RNR element; and
transmitting the RNR element comprising the short SMD ID values assigned to the plurality of reported APs.

16. The non-transitory computer-readable medium of claim 15, wherein the short SMD ID values for the collocated APs are assigned locally and independently without coordination with other APs in a collocated AP set.

17. The non-transitory computer-readable medium of claim 15, wherein assigning the short SMD ID values for the collocated APs comprises:
setting the short SMD ID value for a first reported collocated AP to a first designated value when the first reported collocated AP is affiliated with a same AP Multi-Link Device (MLD) as a reporting AP;
setting the short SMD ID value for a second reported collocated AP to a basic service set ID (BSSID) Index of a non-transmitted BSSID, as carried in a Multiple BSSID-Index element in a non-transmitted BSSID profile of that non-transmitted BSSID, when the second reported collocated AP is affiliated with the same AP MLD as a non-transmitted BSSID in a same Multiple BSSID Set as the reporting AP; and
setting the short SMD ID value for a third reported collocated AP to a value that is unique for the SMD of that reported AP in the RNR element, when the third reported collocated AP is affiliated with an AP MLD that is neither the AP MLD of the reporting AP nor an AP MLD corresponding to a non-transmitted BSSID in the same Multiple BSSID Set as the reporting AP.

18. The non-transitory computer-readable medium of claim 15, wherein assigning the short SMD ID values for the collocated APs comprises using a common management entity such that every reporting AP in a collocated AP set uses coordinated SMD ID values.

19. The non-transitory computer-readable medium of claim 15, wherein the short SMD ID values for the non-collocated APs are assigned locally and independently without coordination with other APs in a collocated AP set.

20. The non-transitory computer-readable medium of claim 15, wherein assigning the short SMD ID values for the non-collocated APs comprising using a common management entity such that every reporting AP in a collocated AP set uses coordinated SMD ID values.
